(19) United States
(12) Patent Application Publication
(10) Pub. No.: US 2007/0281069 A1
(43) Pub. Date: Dec. 6, 2007

(54) Caffeinated coffee drink

(76) Inventors: David Silverglate, Santa Cruz, CA (US); Nathan Silverglate, Santa Cruz, CA (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/807,630

(22) Filed: May 29, 2007

Related U.S. Application Data
(60) Provisional application No. 60/803,690, filed on Jun. 1, 2006.

(51) Int. Cl. A23F 5/00

(52) U.S. Cl. 426/594

(57) ABSTRACT

A beverage and beverage product are disclosed. The beverage product may include a chocolate-flavored milk mixture, and a caffeine additive. Typically, the beverage does not include coffee, tea or cola. The chocolate-flavored milk mixture typically includes milk and cocoa powder. A variety of other ingredients may be added, such as a sweetener, vanilla extract, a mild acid, and/or salt.

### CROSS-REFERENCE TO RELATED APPLICATION

This application claims priority under 35 U.S.C. § 119 to U.S. provisional patent application Ser. No. 60/803,690, entitled CAFFEINATED CHOCOLATE DRINK, filed on Jun. 1, 2006, the entire disclosure of which is herein incorporated by reference.

### BACKGROUND OF THE INVENTION

People drink coffee on a regular basis because coffee provides the effects of warding off drowsiness and restoring alertness. These effects are in large part due to caffeine, a stimulant, which is naturally present in coffee. In addition, the addictive qualities of caffeine perpetuate the desirability of coffee, making people want to drink coffee repeatedly over time.

Although many people enjoy the stimulating effects of coffee, some find the bitter taste of coffee undesirable. Many people find hot chocolate to be a preferable drink in terms of taste compared to coffee. However, hot chocolate often does not include caffeine and may be avoided because of the hearty nature of the beverage.

In some instances, coffee can be combined with chocolate to make a mocha drink. Nevertheless, coffee even in a mocha drink can be overly strong and distasteful. Moreover, coffee has been shown to have many ingredients that are not healthy.

Alternatively, many people choose to drink black and green teas which also contain smaller amounts of caffeine, and contain potentially healthful substances such as antioxidants. But, like coffee, tea also has a bitter taste which many people dislike.

Chocolate, on the other hand, has been shown to have many beneficial effects and a desirable taste. Many people mistakenly think that cocoa beans have caffeine, however cocoa beans actually contain a chemical, theobromine, which does not provide the full stimulating effect of caffeine. Nevertheless, for its taste, chocolate has been considered a fruit of the gods since its discovery by early Native Americans, and thus has been popular throughout recent history.

What is needed is a drink that includes the stimulating effects of caffeine combined with the enjoyable taste of chocolate.

### SUMMARY OF THE INVENTION

A beverage and beverage product are disclosed. According to one aspect, the beverage may include a mixture consisting essentially of milk, cacao powder, sweetener, ascorbic acid, salt, vanilla extract and caffeine. The sweetener may be sugar.

According to another aspect, a beverage product is provided. The beverage product may include a chocolate-flavored milk mixture, and a caffeine additive, wherein the beverage does not include coffee, tea or cola. The milk mixture may further include cocoa powder, and/or a sweetener, which may be sugar. The milk mixture may include a milk selected from the group consisting of soy milk and cow milk. The caffeine contained in a prepared cup of the beverage may be between about 30 and 150 mg. The beverage product may further include preservatives to keep the beverage product fresh over time, anti-caking ingredients, emulsifiers, salt, vanilla extract, and/or a mild acid. The milk mixture, caffeine and other ingredients may be in dehydrated or condensed form, and may be packaged in a ready-to-use container, such as a packet or tin. Or, the milk mixture and caffeine additive may be in liquid form, and may be packaged in a ready-to-drink container, such as a glass bottle, plastic bottle, or can. Typically, all the ingredients are 100% natural.

According to another aspect, a beverage product is provided that includes a mixture of milk, sugar, cocoa powder, salt, vanilla extract, ascorbic acid, and caffeine, in substantially the following ratio prior to mixing: 1 cup milk; 4 tbsp. sugar; 2 tsp. of cocoa powder; a dash of salt; ¼ tsp. vanilla extract; ⅛ tsp. ascorbic acid; and 1/16 tsp. caffeine.

### DETAILED DESCRIPTION

By combining caffeine with chocolate and sweeteners, a beverage may be created that delivers the stimulating properties associated with a strong cup of coffee and the delicious taste and effects of sweet, liquid chocolate, while avoiding the bitter taste associated with coffee. In an exemplary embodiment of the caffeinated chocolate drink, the ingredients of the drink may include cocoa, milk, sugar and caffeine. Typically, the caffeinated chocolate drink does not include other ingredients from coffee beans, tea leaves or cola nuts.

The concentration of caffeine may differ based on a desired level of stimulation. For example, one serving of the beverage may include a dose of 100 mg or approximately 1/16 of a teaspoon of 100% pure, natural caffeine. This dose may be similar to one cup of drip brewed coffee. In some embodiment of the beverage the added caffeine may be natural, while in other embodiment the caffeine may be synthetic.

Moreover, an exemplary embodiment of the caffeinated chocolate beverage may be categorized by the amount of caffeine in the beverage. For example a beverage which includes 100 mg of caffeine may be characterized as regular strength. Additionally, a beverage that includes 30 mg of caffeine may be characterized as light. Finally, a beverage that includes 150 mg of caffeine may be categorized as extra strength. It should be appreciated that the above discussed doses are purely exemplary and other desired amounts of caffeine may be included in the beverage without departing from the scope of this disclosure.

Furthermore, in some embodiments, the caffeine included in the beverage may be synthetic. Further, in other embodiments, the caffeine included in the beverage may be natural. Such a beverage may be created with 100% natural ingredients by using natural caffeine and other natural ingredients.

In some embodiments, the quantity of each ingredient included in the beverage may differ based on a desired taste or effect. For example, the drink may include more sugar than regular hot chocolate to cover any bitterness from the addition of caffeine. Additional ingredients that can be added to the caffeinated chocolate beverage to cut the bitterness may include sugar or a mild acid, for example, a mild natural acid such as ascorbic acid.

In some embodiments, additional ingredients may be included in order to create a ready-to-drink version such as maltodextrin and pectin. Furthermore, various ingredients may be included in order to create powdered (dehydrated), or condensed, ready-to-use versions, for example, dairy product solids, cellulose gum, guar gum, salt, sodium caseinate, dipotassium phosphate, mono diglycerides, etc. These and other ingredients may be included to keep the product from caking or for freshness, “mouth-feel” (how good it feels in your mouth) and preservation.

Another exemplary embodiment of the caffeinated chocolate drink may include additional flavor enhancing ingredients without departing from the scope of this disclosure. Exemplary ingredient may include mint, marshmallow, cinnamon, or other ingredients which may be desirable when combined with chocolate.

In some embodiments of the caffeinated chocolate beverage, cow milk may be substituted with other ingredients such as soy milk, rice milk and goat milk. In some embodiments milk may be avoided altogether. Further, sugar substitutes may be used in place of sugar and non-fat milk may replace whole milk.

The caffeinated chocolate beverage may take different forms based on the method of distribution. For example, the beverage may be distributed in individual serving bottles that are ready-to-drink, gallon jugs (such as for restaurants) that are ready-to-use, sealed packets of powder of instant mix, containers of powder (similar to many instant hot chocolate drinks), or any other desirable delivery system. The product further may be distributed as concentrate syrup for example without milk in gallon containers for restaurants.

The ingredients used to make the caffeinated chocolate beverage permit the beverage to be consumed warmed or chilled. The beverage may be desirable to drink during all seasons because the drink may be served hot during colder seasons, such as during the Fall and Winter; moreover the drink may be served cold during the warmer seasons, such as Spring and Summer.

The caffeinated chocolate beverage may be consumed by a large and diverse population. This is due in part to the fact that caffeine is the only legal stimulant for all ages in most western countries. Furthermore, caffeine while considered a drug is widely accepted in the workplace because it can make people more alert and productive without the negative effects associated with other stimulants.

In some cases, beverages have been marketed for their lack of caffeine, due to many real or perceived problems with caffeine, for example, insomnia, anxiety, restlessness, etc. Due in part to the negative publicity associated with caffeine as well as other factors, natural caffeine has become readily available at very reasonable prices. In some cases, the degree of availability of natural caffeine can be associated with the byproduct yield from the decaffeinization process. Since caffeine may be inexpensive and widely available, the cost of production of the caffeinated chocolate beverage may be lower resulting in higher profitability. Caffeine is a natural ingredient of coffee beans, black & green tea leaves and cola nuts. Other drinks that include caffeine are soft drinks such as Coke™ and sport drinks like Red Bull™.

Example Recipe

Serving size=1 cup

1 cup milk

4 tbsp. sugar

2 tsp. of cocoa powder

A dash of salt

¼ tsp. vanilla extract

⅛ tsp. ascorbic acid

1/16 tsp. caffeine

Instructions: Mix ingredients together and serve hot or cold. White chocolate shavings may be substituted for cocoa powder, with an appropriate reduction in sugar. Sugar substitutes may be substituted for sugar.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A beverage, comprising:
a mixture consisting essentially of milk, cacao powder, sweetener, ascorbic acid, salt, vanilla extract and caffeine.

2. The beverage of claim 1, wherein the sweetener is sugar.

3. A beverage product, comprising:
a chocolate-flavored mixture; and
a caffeine additive;
wherein the beverage does not include coffee, tea or cola.

4. The beverage product of claim 3, wherein the chocolate-flavored mixture is a chocolate-flavored milk mixture including a milk selected from the group consisting of soy milk, cow milk, rice milk, and goat milk.

5. The beverage product of claim 4, wherein the milk mixture further includes a sweetener.

6. The beverage product of claim 5, wherein the sweetener is sugar.

7. The beverage product of claim 4, wherein the caffeine contained in a prepared cup of the beverage is between about 30 and 150 mg.

8. The beverage product of claim 4, further comprising:
at least one of preservatives to keep the beverage product fresh over time, emulsifiers, and anti-caking ingredients.

9. The beverage product of claim 4, wherein the milk mixture includes cocoa powder.

10. The beverage product of claim 4, wherein the milk mixture and caffeine are in dehydrated or condensed form.

11. The beverage product of claim 10, wherein the beverage product is packaged in a ready-to-use container.

12. The beverage product of claim 11, wherein the ready-to-use container is selected from the group consisting of a packet or tin.

13. The beverage product of claim 4, wherein the milk mixture and caffeine additive are in liquid form.

14. The beverage product of claim 13, wherein the beverage is packaged in a ready-to-drink container.

15. The beverage product of claim 14, wherein the ready-to-use container is selected from the group consisting of a glass bottle, plastic bottle, or can.

16. The beverage product of claim 4, wherein the milk mixture further includes salt.

17. The beverage product of claim 4, wherein the milk mixture further includes a mild acid.

18. The beverage product of claim 4, wherein the milk mixture further includes vanilla extract.

19. The beverage of claim 4, wherein all the ingredients are 100% natural.

20. A beverage product, comprising:
a mixture of milk, sugar, cocoa powder, salt, vanilla extract, ascorbic acid, and caffeine, in substantially the following ratio prior to mixing:
1 cup milk;
4 tbsp. sugar;
2 tsp. of cocoa powder;
a dash of salt;
¼ tsp. vanilla extract;
⅛ tsp. ascorbic acid;
1/16 tsp. caffeine.
